(19) United States
(12) Patent Application Publication
(10) Pub. No.: US 2026/0006582 A1
(43) Pub. Date: Jan. 1, 2026

(54) SIGNAL ENHANCEMENT FOR PAGING ADAPTATION

(71) Applicant: QUALCOMM Incorporated, San Diego, CA (US)

(72) Inventors: Ahmed BEDEWY, Hillsborough, NJ (US); Naeem AKL, Bridgewater, NJ (US); Navid ABEDINI, Basking Ridge, NJ (US); Qing LI, Princeton Junction, NJ (US); Jae Ho RYU, San Diego, CA (US)

(21) Appl. No.: 18/761,102

(22) Filed: Jul. 1, 2024

(51) Int. Cl. H04W 68/02; H04W 8/22; H04W 76/28

(52) U.S. Cl. CPC H04W 68/02; H04W 8/22; H04W 76/28

(57) ABSTRACT

A method for wireless communication at a lower-tier network node includes receiving, from a higher-tier network node, a message indicating a paging request for a user equipment (UE) of a group of UEs served by the lower-tier network node and a paging capability of the UE, the paging capability being associated with either a first paging frame configuration that distributes one or more paging frames within a discontinuous reception (DRX) cycle, irrespective of a paging frame interval or a second paging frame configuration that uniformly distributes the one or more paging frames within the DRX cycle in accordance with the paging frame interval. The method also includes transmitting, to the UE in accordance with receiving the first message, one or more paging messages in accordance with the UE's paging capability. The method further includes receiving, from the UE, a paging response based on transmitting the one or more paging messages.

### FIELD OF THE DISCLOSURE

The present disclosure relates generally to wireless communications, and more specifically to signal enhancement for paging adaptation.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (for example, bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communication network may include a number of base stations (BSs) that can support communications for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (for example, also known as discrete Fourier transform spread OFDM (DFT-s-OFDM)) on the uplink (UL), as well as supporting beamforming, multiple-input multiple-output (MIMO) antenna technology, and carrier aggregation.

In wireless communication networks, a paging message may notify a UE of an incoming call, a message, or other data while the UE is in an idle or inactive state. To conserve battery power, the UE may use a discontinuous reception (DRX) technique to cycle between low-power sleep states and brief wake periods. The UE may check for paging messages during the wake periods. Each paging message may be sent during a respective paging occasion of one or more paging occasions within a paging frame. Each paging frame corresponds to a single radio frame. In some wireless communication systems, such as Release 18 (Rel-18) systems, a group of paging frames within a DRX cycle may be uniformly distributed at intervals of TIN, where T represents a length (for example, a quantity of frames) of the DRX cycle and N represents a quantity of paging frames allocated to the DRX cycle. The interval TIN may be an example of a paging frame interval. In some other wireless communication systems, such as Release 19 (Rel-19) systems and beyond, a network node may allocate a group of paging frames within the DRX cycle, irrespective of the paging frame interval.

### SUMMARY

In aspects of the present disclosure, a method for wireless communication at a lower-tier network node includes receiving, from a higher-tier network node, a first message indicating a paging request for a first user equipment (UE) of a group of UEs served by the lower-tier network node and a paging capability of the first UE. The paging capability may be associated with either a first paging frame configuration that distributes one or more paging frames within a discontinuous reception (DRX) cycle, irrespective of a paging frame interval or a second paging frame configuration that uniformly distributes the one or more paging frames within the DRX cycle in accordance with the paging frame interval. The method further includes transmitting, to the first UE in accordance with receiving the first message, one or more paging messages in accordance with the paging capability of the first UE. The method also includes receiving, from the first UE, a paging response in accordance with transmitting the one or more paging messages.

Other aspects of the present disclosure are directed to an apparatus. The apparatus includes means for receiving, from a higher-tier network node, a first message indicating a paging request for a first UE of a group of UEs served by the lower-tier network node and a paging capability of the first UE. The paging capability may be associated with either a first paging frame configuration that distributes one or more paging frames within a DRX cycle, irrespective of a paging frame interval or a second paging frame configuration that uniformly distributes the one or more paging frames within the DRX cycle in accordance with the paging frame interval. The apparatus also includes means for transmitting, to the first UE in accordance with receiving the first message, one or more paging messages in accordance with the paging capability of the first UE. The apparatus further includes means for receiving, from the first UE, a paging response in accordance with transmitting the one or more paging messages.

In other aspects of the present disclosure, a non-transitory computer-readable medium with program code recorded thereon is disclosed. The program code is executed by one or more processors and includes program code to receive, from a higher-tier network node, a first message indicating a paging request for a first UE of a group of UEs served by the lower-tier network node and a paging capability of the first UE. The paging capability may be associated with either a first paging frame configuration that distributes one or more paging frames within a DRX cycle, irrespective of a paging frame interval or a second paging frame configuration that uniformly distributes the one or more paging frames within the DRX cycle in accordance with the paging frame interval. The program code further includes program code to transmit, to the first UE in accordance with receiving the first message, one or more paging messages in accordance with the paging capability of the first UE. The program code also includes program code to receive, from the first UE, a paging response in accordance with transmitting the one or more paging messages.

Other aspects of the present disclosure are directed to a lower-tier network node including one or more processors, and one or more memories coupled with the one or more processors and storing processor-executable code that, when executed by the one or more processors, is configured to cause the lower-tier network node to receive, from a higher-tier network node, a first message indicating a paging request for a first UE of a group of UEs served by the lower-tier network node and a paging capability of the first UE. The paging capability may be associated with either a first paging frame configuration that distributes one or more paging frames within a DRX cycle, irrespective of a paging frame interval or a second paging frame configuration that uniformly distributes the one or more paging frames within the DRX cycle in accordance with the paging frame interval. Execution of the processor-executable code also causes the lower-tier network node to transmit, to the first UE in accordance with receiving the first message, one or more paging messages in accordance with the paging capability of the first UE. Execution of the processor-executable code further causes the lower-tier network node to receive, from the first UE, a paging response in accordance with transmitting the one or more paging messages.

In aspects of the present disclosure, a method for wireless communication at a UE includes transmitting, to a network node, a first message indicating a paging capability of the UE, the paging capability being either a first paging frame configuration that distributes one or more paging frames within a DRX cycle irrespective of a paging frame interval or a second paging frame configuration that uniformly distributes the one or more paging frames within the DRX cycle in accordance with the paging frame interval. The method further includes receiving, in accordance with the paging capability being associated with the first paging frame configuration, a second message indicating an authorization for the UE to receive one or more paging messages in accordance with the first paging frame configuration. The method also includes receiving, from the network node in accordance with receiving the second message, the one or more paging messages in accordance with the first paging frame configuration.

Other aspects of the present disclosure are directed to an apparatus. The apparatus includes means for transmitting, to a network node, a first message indicating a paging capability of the UE, the paging capability being either a first paging frame configuration that distributes one or more paging frames within a DRX cycle irrespective of a paging frame interval or a second paging frame configuration that uniformly distributes the one or more paging frames within the DRX cycle in accordance with the paging frame interval. The apparatus also includes means for receiving, in accordance with the paging capability being associated with the first paging frame configuration, a second message indicating an authorization for the UE to receive one or more paging messages in accordance with the first paging frame configuration. The apparatus further includes means for receiving, from the network node in accordance with receiving the second message, the one or more paging messages in accordance with the first paging frame configuration.

In other aspects of the present disclosure, a non-transitory computer-readable medium with program code recorded thereon is disclosed. The program code is executed by one or more processors and includes program code to transmit, to a network node, a first message indicating a paging capability of the UE, the paging capability being either a first paging frame configuration that distributes one or more paging frames within a DRX cycle irrespective of a paging frame interval or a second paging frame configuration that uniformly distributes the one or more paging frames within the DRX cycle in accordance with the paging frame interval. The program code further includes program code to receive, in accordance with the paging capability being associated with the first paging frame configuration, a second message indicating an authorization for the UE to receive one or more paging messages in accordance with the first paging frame configuration. The program code also includes program code to receive, from the network node in accordance with receiving the second message, the one or more paging messages in accordance with the first paging frame configuration.

Other aspects of the present disclosure are directed to a UE including one or more processors, and one or more memories coupled with the one or more processors and storing processor-executable code that, when executed by the one or more processors, is configured to cause the UE to transmit, to a network node, a first message indicating a paging capability of the UE, the paging capability being either a first paging frame configuration that distributes one or more paging frames within a DRX cycle irrespective of a paging frame interval or a second paging frame configuration that uniformly distributes the one or more paging frames within the DRX cycle in accordance with the paging frame interval. Execution of the processor-executable code also causes the UE to receive, in accordance with the paging capability being associated with the first paging frame configuration, a second message indicating an authorization for the UE to receive one or more paging messages in accordance with the first paging frame configuration. Execution of the processor-executable code further causes the UE receive, from the network node in accordance with receiving the second message, the one or more paging messages in accordance with the first paging frame configuration.

Aspects generally include a method, apparatus, system, computer program product, non-transitory computer-readable medium, user equipment, base station, wireless communication device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a user equipment (UE) in a wireless communication network, in accordance with various aspects of the present disclosure.

FIG. 3 is a block diagram illustrating an example disaggregated base station architecture, in accordance with various aspects of the present disclosure.

FIG. 4 is a block diagram illustrating an example of a Release 18 (Rel-18) paging frame configuration, in accordance with various aspects of the present disclosure.

FIG. 5 is a block diagram illustrating an example of adaptive paging, in accordance with various aspects of the present disclosure.

FIG. 6 is a timing diagram illustrating an example of a higher-tier network node indicating UE capability information to a lower-tier network node, in accordance with various aspects of the present disclosure.

FIGS. 7 and 8 are block diagrams illustrating examples of network layouts, in accordance with various aspects of the present disclosure.

FIG. 9 is a block diagram illustrating an example wireless communication device that supports adapting signaling based on a UE capability, in accordance with various aspects of the present disclosure.

FIG. 10 is a flow diagram illustrating an example of a process for adapting signaling in accordance with a UE's capability, in accordance with various aspects of the present disclosure.

FIG. 11 is a block diagram illustrating an example wireless communication device that supports adaptive signaling in accordance with a UE capability, in accordance with various aspects of the present disclosure.

FIG. 12 is a flow diagram illustrating an example of a process for adapting signaling in accordance with a UE's capability, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G, 6G, and later wireless technologies, aspects of the present disclosure can be applied in other generation-based communications systems, such as and including 3G and/or 4G technologies.

In wireless communication networks, a paging message may notify a UE of an incoming call, a message, or other data while the UE is in an idle or inactive state. To conserve battery power, the UE may use a discontinuous reception (DRX) technique to cycle between low-power sleep states and brief wake periods. The UE may check for paging messages during the wake periods. Each paging message may be sent during a respective paging occasion of one or more paging occasions within a paging frame. Each paging frame corresponds to a single radio frame. In some wireless communication systems, such as Release 18 (Rel-18) systems, a group of paging frames within a DRX cycle may be uniformly distributed at intervals of TIN, where T represents a length (for example, a quantity of frames) of the DRX cycle and N represents a quantity of paging frames allocated to the DRX cycle. The interval TIN may be an example of a paging frame interval. For ease of explanation, in the present application, a Rel-18 paging frame configuration refers to a group of paging frames uniformly distributed within a DRX cycle in accordance with the paging frame interval.

In some other wireless communication systems, such as Release 19 (Rel-19) systems and beyond, adaptive paging may be enabled for one or more cells associated with a network node. In such examples, when adaptive paging is enabled, the network node may allocate a group of paging frames within the DRX cycle, irrespective of the paging frame interval. Specifically, in such examples, the network node may schedule the paging frames, such that paging occasions align with a cell's discontinuous transmission (DTX) cycle. Aligning paging occasions with the DTX cycle reduces network overhead because the network node does not need to schedule the paging messages for all UEs in the cell within the same paging frame. For ease of explanation, in the present application, a Rel-19 paging frame configuration refers to a group of paging frames distributed within a DRX cycle, irrespective of the paging frame interval.

A wireless communication network may include different tiers of network nodes. For example, the wireless communication network may include higher-tier network nodes and lower-tier network nodes. Paging for a UE is initiated by a higher-tier network node, such as a central unit (CU) or an access and mobility management function (AMF). This higher-tier network node sends the paging request to a lower-tier network node, such as a distributed unit (DU), a base station (for example, gNodeB (gNB)), or a neighboring node. The lower-tier network node may transmit one or more paging messages to a UE in accordance with receiving the paging request from the higher-tier network node. Lower-tier network nodes do not store detailed capability information about UEs. This capability information may indicate whether a UE is a Rel-18 capable UE or a Rel-19 capable UE.

When a lower-tier network node has activated Rel-19 features, such as paging adaptation, the lower-tier network node does not know if a served UE is capable of supporting the activated Rel-19 features. For example, the lower-tier network node may be unaware of whether a paged UE is a Rel-18 capable UE or a Rel-19 capable UE that can take advantage of the paging adaptation. The Rel-19 capable UE may support both a Rel-19 paging frame configuration and a Rel-18 paging frame configuration. The Rel-18 capable UE may only support the Rel-18 paging frame configuration. In such an example, without knowing the UE's capability, the lower-tier network node cannot determine whether to use the Rel-19 paging frame configuration or the Rel-18 paging frame configuration. This uncertainty can lead to ineffective paging operations because the lower-tier network node may use an incorrect paging configuration when paging one or more UEs. For example, using the Rel-19 paging frame configuration on the Rel-18 capable UE may result in the Rel-18 capable UE missing one or more paging messages because the Rel-18 capable UE may not monitor paging occasions included in one or more paging frames allocated in accordance with the Rel-19 paging frame configuration. As another example, using the Rel-18 paging frame configuration on the Rel-19 capable UE may result in network inefficiencies as the lower-tier network node may not offload one or more paging messages to paging frames allocated in accordance with the Rel-19 paging frame configuration.

Various aspects of the present disclosure are directed to a higher-tier network node indicating UE capability information to a lower-tier network node. The capability information may be used by the lower-tier network node to adapt signaling to one or more UEs served by the lower-tier network node. In some examples, a lower-tier network node may receive from a higher-tier network node, a first message indicating a paging request for a first UE of a group of UEs served by the lower-tier network node and a paging capability of the first UE. The paging capability may be associated with either a Rel-19 paging frame configuration (for example, first paging frame configuration) that distributes one or more paging frames within a DRX cycle, irrespective of a paging frame interval or a Rel-18 paging frame configuration (for example, second paging frame configuration) that uniformly distributes the one or more paging frames within the DRX cycle in accordance with the paging frame interval.

The paging capability of the first UE may be known to the higher-tier network node based on signaling provided to the higher-tier network node when the first UE initially connects with the lower-tier network node. In some examples, signaling may include the first UE's capability information, which may indicate whether the UE supports a Rel-18 paging frame configuration or a Rel-19 paging frame configuration. The capability information may also indicate support for other features that may be specific to one or more Standards Releases, such as, but not limited to, random access channel (RACH) occasion (RO) adaptation or paging early indication. The lower-tier network node does not store this capability information. In accordance with receiving the first message, the lower-tier network node may then transmit, to the first UE, one or more paging messages in accordance with the paging capability of the first UE. The lower-tier network node may then receive, from the first UE, a paging response in accordance with transmitting the one or more paging messages.

In some examples, only a subset of UEs, from a set of UEs associated with a Rel-19 paging frame configuration, may be authorized to receive paging messages in accordance with the Rel-19 paging frame configuration. As previously discussed, a UE may transmit, to a lower-tier network node, a first message indicating a paging capability of the UE. The UE may then receive, in accordance with the paging capability being associated with the Rel-19 paging frame configuration, a second message indicating the UE is authorized to receive one or more paging messages in accordance with the Rel-19 paging frame configuration. The second message may be a radio resource control (RRC) message, a non-access stratum message, a user plan message, or a system information message. The UE may then receive, from the lower-tier network node, in accordance with receiving the second message, the one or more paging messages in accordance with the Rel-19 paging frame configuration.

Particular aspects of the subject matter described in this disclosure can be implemented to realize one or more of the following potential advantages. In some examples, the described techniques, of indicating a UEs paging capability may allow a lower-tier network node to use an appropriate paging frame configuration when transmitting one or more paging messages to a UE. Using the appropriate paging frame prevents transmission of the one or more paging messages to UEs that are incapable of receiving the one or more paging messages. Preventing the transmission of paging message transmissions to UEs that are incapable of receiving such paging messages may conserve network resources and reduce power consumption. Additionally, in some examples, the described techniques of only authorizing a subset of UEs to receive paging messages in accordance with a specific paging frame configuration, such as a Rel-19 paging frame configuration, may allow a network to create a special class of UEs with reduced paging overhead.

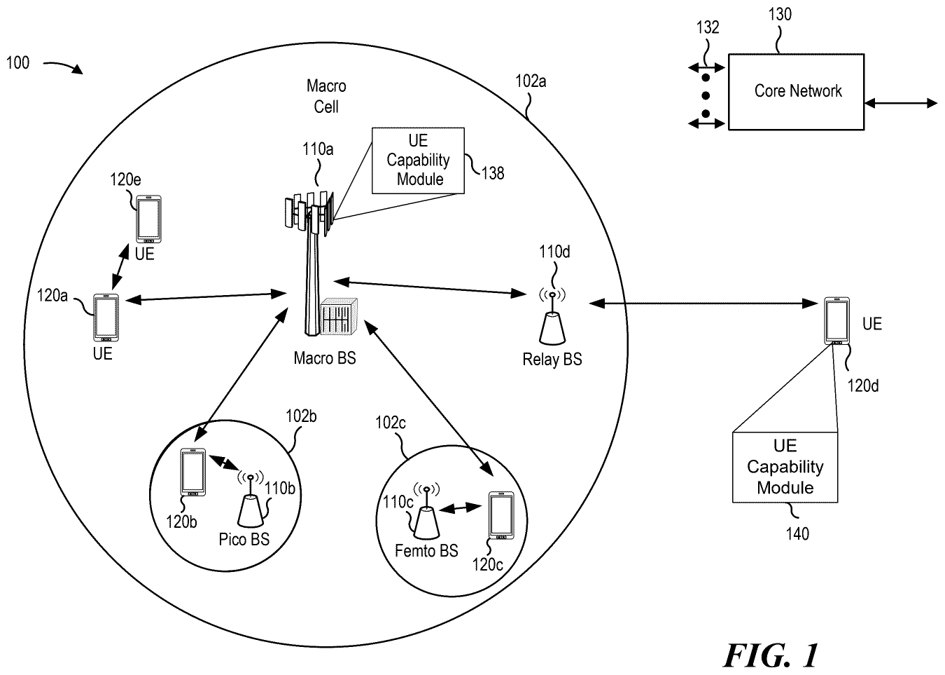

FIG. 1 is a diagram illustrating a wireless network 100 in which aspects of the present disclosure may be practiced. The wireless network 100 may be a 5G or NR network or some other wireless network, such as an LTE network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G Node B, an access point, a transmit and receive point (TRP), a network node, a network entity, and/or the like. A base station can be implemented as an aggregated base station, as a disaggregated base station, an integrated access and backhaul (IAB) node, a relay node, a sidelink node, etc. The base station can be implemented in an aggregated or monolithic base station architecture, or alternatively, in a disaggregated base station architecture, and may include one or more of a central unit (CU), a distributed unit (DU), a radio unit (RU), a near-real time (near-RT) RAN intelligent controller (RIC), or a non-real time (non-RT) RIC.

Each BS may provide communications coverage for a particular geographic area. In 3GPP, the term “cell” can refer to a coverage area of a BS and/or a BS subsystem serving this coverage area, depending on the context in which the term is used.

A BS may provide communications coverage for a macro cell, a pico cell, a femto cell, and/or another type of cell. A macro cell may cover a relatively large geographic area (for example, several kilometers in radius) and may allow unrestricted access by UEs with service subscription. A pico cell may cover a relatively small geographic area and may allow unrestricted access by UEs with service subscription. A femto cell may cover a relatively small geographic area (for example, a home) and may allow restricted access by UEs having association with the femto cell (for example, UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (for example, three) cells. The terms “eNB,” “base station,” “NR BS,” “g B,” “AP,” “Node B,” “5G NB,” “TRP,” and “cell” may be used interchangeably.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

The wireless network 100 may also include relay stations. A relay station is an entity that can receive a transmission of data from an upstream station (for example, a BS or a UE) and send a transmission of the data to a downstream station (for example, a UE or a BS). A relay station may also be a UE that can relay transmissions for other UEs. In the example shown in FIG. 1, a relay station 110d may communicate with macro BS 110a and a UE 120d in order to facilitate communications between the BS 110a and UE 120d. A relay station may also be referred to as a relay BS, a relay base station, a relay, and/or the like.

The wireless network 100 may be a heterogeneous network that includes BSs of different types (for example, macro BSs, pico BSs, femto BSs, relay BSs, and/or the like). These different types of BSs may have different transmit power levels, different coverage areas, and different impact on interference in the wireless network 100. For example, macro BSs may have a high transmit power level (for example, 5 to 40 watts) whereas pico BSs, femto BSs, and relay BSs may have lower transmit power levels (for example, 0.1 to 2 watts).

As an example, the BSs 110 (shown as BS 110a, BS 110b, BS 110c, and BS 110d) and the core network 130 may exchange communications via backhaul links 132 (for example, S1, etc.). Base stations 110 may communicate with one another over other backhaul links (for example, X2, etc.) either directly or indirectly (for example, through core network 130).

The core network 130 may be an evolved packet core (EPC), which may include at least one mobility management entity (MME), at least one serving gateway (S-GW), and at least one packet data network (PDN) gateway (P-GW). The MME may be the control node that processes the signaling between the UEs 120 and the EPC. All user IP packets may be transferred through the S-GW, which itself may be connected to the P-GW. The P-GW may provide IP address allocation as well as other functions. The P-GW may be connected to the network operator's IP services. The operator's IP services may include the Internet, the Intranet, an IP multimedia subsystem (IMS), and a packet-switched (PS) streaming service.

The core network 130 may provide user authentication, access authorization, tracking, IP connectivity, and other access, routing, or mobility functions. One or more of the base stations 110 or access node controllers (ANCs) may interface with the core network 130 through backhaul links 132 (for example, S1, S2, etc.) and may perform radio configuration and scheduling for communications with the UEs 120. In some configurations, various functions of each access network entity or base station 110 may be distributed across various network devices (for example, radio heads and access network controllers) or consolidated into a single network device (for example, a base station 110).

UEs 120 (for example, 120a, 120b, 120c) may be dispersed throughout the wireless network 100, and each UE may be stationary or mobile. A UE may also be referred to as an access terminal, a terminal, a mobile station, a subscriber unit, a station, and/or the like. A UE may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

One or more UEs 120 may establish a protocol data unit (PDU) session for a network slice. In some cases, the UE 120 may select a network slice based on an application or subscription service. By having different network slices serving different applications or subscriptions, the UE 120 may improve its resource utilization in the wireless network 100, while also satisfying performance specifications of individual applications of the UE 120. In some cases, the network slices used by UE 120 may be served by an AMF (not shown in FIG. 1) associated with one or both of the base station 110 or core network 130. In addition, session management of the network slices may be performed by an access and mobility management function (AMF).

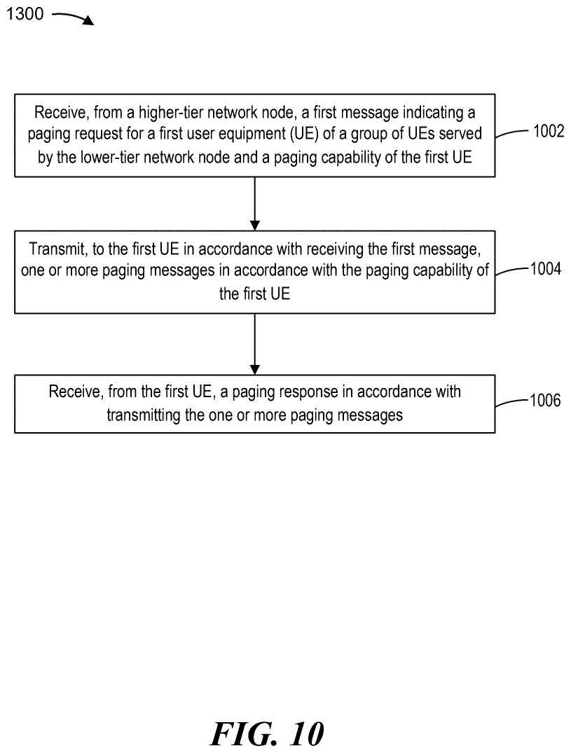

The UEs 120 may include a UE capability module 140. For brevity, only one UE 120d is shown as including the UE capability module 140. The UE capability module 140 may perform one or more operations such as one or more operations of the process 1000 described with reference to FIG. 10.

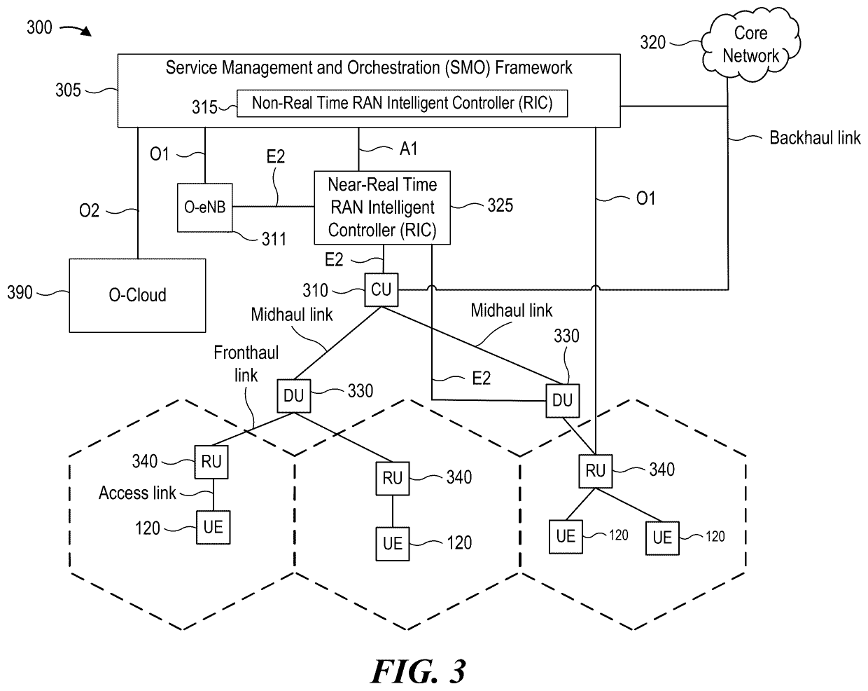

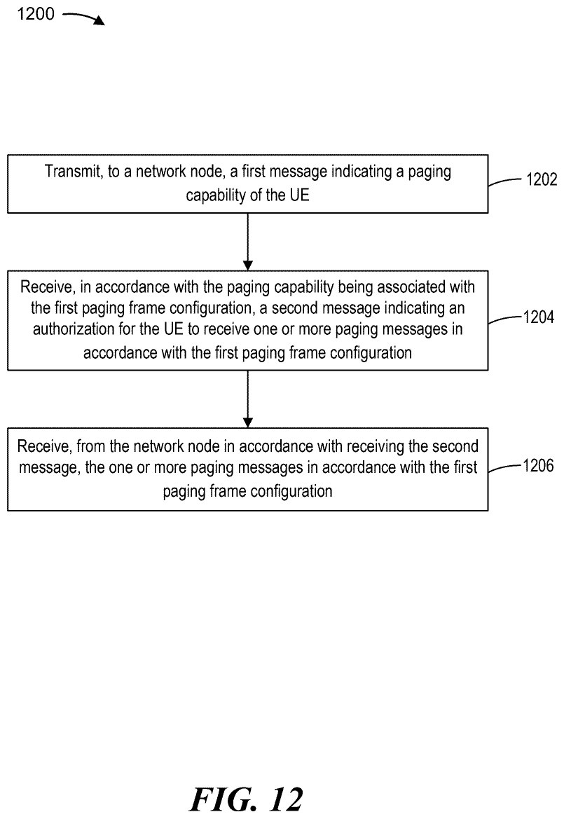

The core network 130 or the base stations 110 or any other network device (for example, as seen in FIG. 3) may include a UE capability module 138 that performs one or more operations such as one or more operations of the process 1200 described with reference to FIG. 12.

Some UEs may be considered machine-type communications (MTC) or evolved or enhanced machine-type communications (eMTC) UEs. MTC and eMTC UEs include, for example, robots, drones, remote devices, sensors, meters, monitors, location tags, and/or the like, that may communicate with a base station, another device (for example, remote device), or some other entity. A wireless node may provide, for example, connectivity for or to a network (for example, a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a customer premises equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (for example, shown as UE 120a and UE 120e) may communicate directly using one or more sidelink channels (for example, without using a base station 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere as being performed by the base station 110. For example, the base station 110 may configure a UE 120 via downlink control information (DCI), radio resource control (RRC) signaling, a media access control-control element (MAC-CE) or via system information (for example, a system information block (SIB).

As indicated above, FIG. 1 is provided merely as an example. Other examples may differ from what is described with regard to FIG. 1.

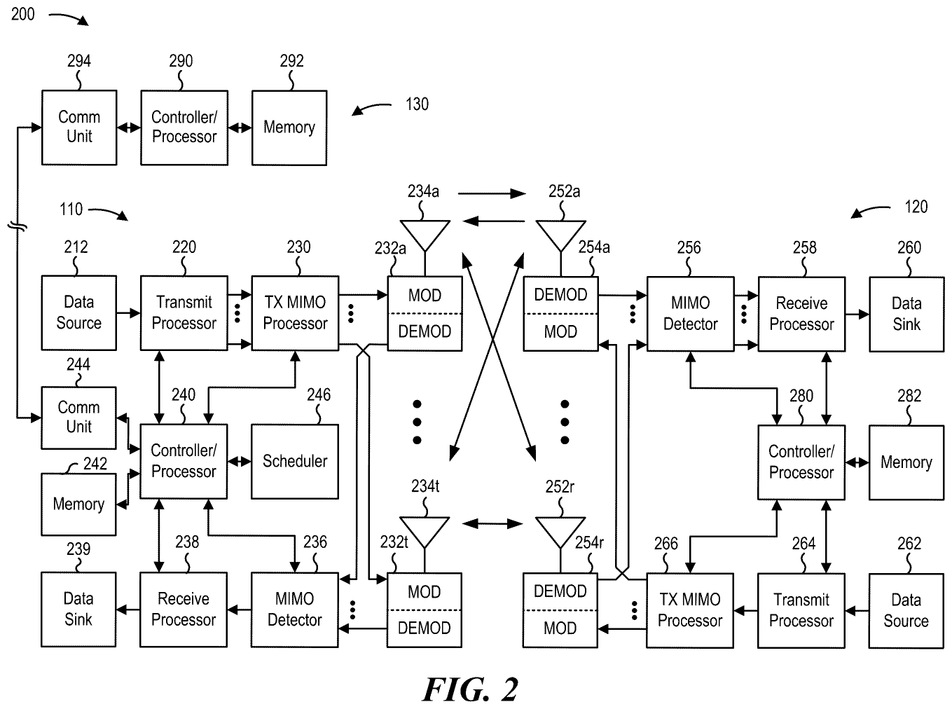

FIG. 2 shows a block diagram of a design 200 of the base station 110 and UE 120, which may be one of the base stations and one of the UEs in FIG. 1. The base station 110 may be equipped with T antennas 234a through 234t, and UE 120 may be equipped with R antennas 252a through 252r, where in general T≥1 and R≥1.

At the base station 110, a transmit processor 220 may receive data from a data source 212 for one or more UEs, select one or more modulation and coding schemes (MCS) for each UE based at least in part on channel quality indicators (CQIs) received from the UE, process (for example, encode and modulate) the data for each UE based at least in part on the MCS(s) selected for the UE, and provide data symbols for all UEs. Decreasing the MCS lowers throughput but increases reliability of the transmission. The transmit processor 220 may also process system information (for example, for semi-static resource partitioning information (SRPI) and/or the like) and control information (for example, CQI requests, grants, upper layer signaling, and/or the like) and provide overhead symbols and control symbols. The transmit processor 220 may also generate reference symbols for reference signals (for example, the cell-specific reference signal (CRS)) and synchronization signals (for example, the primary synchronization signal (PSS) and secondary synchronization signal (SSS)). A transmit (TX) multiple-input multiple-output (MIMO) processor 230 may perform spatial processing (for example, precoding) on the data symbols, the control symbols, the overhead symbols, and/or the reference symbols, if applicable, and may provide T output symbol streams to T modulators (MODs) 232a through 232t. Each modulator 232 may process a respective output symbol stream (for example, for orthogonal frequency division multiplexing (OFDM) and/or the like) to obtain an output sample stream. Each modulator 232 may further process (for example, convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At the UE 120, antennas 252a through 252r may receive the downlink signals from the base station 110 and/or other base stations and may provide received signals to demodulators (DEMODs) 254a through 254r, respectively. Each demodulator 254 may condition (for example, filter, amplify, downconvert, and digitize) a received signal to obtain input samples. Each demodulator 254 may further process the input samples (for example, for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (for example, demodulate and decode) the detected symbols, provide decoded data for the UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of the UE 120 may be included in a housing.

On the uplink, at the UE 120, a transmit processor 264 may receive and process data from a data source 262 and control information (for example, for reports comprising RSRP, RSSI, RSRQ, CQI, and/or the like) from the controller/processor 280. Transmit processor 264 may also generate reference symbols for one or more reference signals. The symbols from the transmit processor 264 may be precoded by a TX MIMO processor 266 if applicable, further processed by modulators 254a through 254r (for example, for discrete Fourier transform spread OFDM (DFT-s-OFDM), CP-OFDM, and/or the like), and transmitted to the base station 110. At the base station 110, the uplink signals from the UE 120 and other UEs may be received by the antennas 234, processed by the demodulators 254, detected by a MIMO detector 236 if applicable, and further processed by a receive processor 238 to obtain decoded data and control information sent by the UE 120. The receive processor 238 may provide the decoded data to a data sink 239 and the decoded control information to a controller/processor 240. The base station 110 may include communications unit 244 and communicate to the core network 130 via the communications unit 244. The core network 130 may include a communications unit 294, a controller/processor 290, and a memory 292.

The controller/processor 240 of the base station 110, the controller/processor 280 of the UE 120, and/or any other component(s) of FIG. 2 may perform one or more techniques associated with indicating UE capability and/or adapting signaling based on a capability of a UE 120, as described in more detail elsewhere. For example, the controller/processor 240 of the base station 110, the controller/processor 280 of the UE 120, and/or any other component(s) of FIG. 2 may perform or direct operations of, for example, the processes of FIGS. 10 and 12 and/or other processes as described. Memories 242 and 282 may store data and program codes for the base station 110 and UE 120, respectively. A scheduler 246 may schedule UEs for data transmission on the downlink and/or uplink.

As indicated above, FIG. 2 is provided merely as an example. Other examples may differ from what is described with regard to FIG. 2.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), an evolved NB (eNB), an NR BS, 5G NB, an access point (AP), a transmit and receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU, and RU also can be implemented as virtual units (for example, a virtual central unit (VCU), a virtual distributed unit (VDU), or a virtual radio unit (VRU)).

Base station-type operations or network designs may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

In some cases, different types of devices supporting different types of applications and/or services may coexist in a cell. Examples of different types of devices include UE handsets, customer premises equipment (CPEs), vehicles, Internet of Things (IoT) devices, and/or the like. Examples of different types of applications include ultra-reliable low-latency communications (URLLC) applications, massive machine-type communications (mMTC) applications, enhanced mobile broadband (eMBB) applications, vehicle-to-anything (V2X) applications, and/or the like. Furthermore, in some cases, a single device may support different applications or services simultaneously.

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a near-real time (near-RT) RAN intelligent controller (RIC) 325 via an E2 link, or a non-real time (non-RT) RIC 315 associated with a service management and orchestration (SMO) framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (for example, the CUs 310, the DUs 330, the RUs 340, as well as the near-RT RICs 325, the non-RT RICs 315, and the SMO framework 305) may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (for example, central unit-user plane (CU-UP)), control plane functionality (for example, central unit-control Plane (CU-CP)), or a combination thereof. In some implementations, the CU 310 can be logically split into one or more CU-UP units and one or more CU-CP units. The CU-UP unit can communicate bi-directionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the Third Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 120. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO framework 305 may be configured to support RAN deployment and provisioning of non-virtualized and virtualized network elements. For non-virtualized network elements, the SMO framework 305 may be configured to support the deployment of dedicated physical resources for RAN coverage requirements, which may be managed via an operations and maintenance interface (such as an O1 interface). For virtualized network elements, the SMO framework 305 may be configured to interact with a cloud computing platform (such as an open cloud (O-cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and near-RT RICs 325. In some implementations, the SMO framework 305 can communicate with a hardware aspect of a 4G RAN, such as an open eNB (O-eNB) 311, via an O1 interface. Additionally, in some implementations, the SMO framework 305 can communicate directly with one or more RUs 340 via an O1 interface. The SMO framework 305 also may include a non-RT RIC 315 configured to support functionality of the SMO framework 305.

The non-RT RIC 315 may be configured to include a logical function that enables non-real-time control and optimization of RAN elements and resources, artificial intelligence/machine learning (AI/ML) workflows including model training and updates, or policy-based guidance of applications/features in the near-RT RIC 325. The non-RT RIC 315 may be coupled to or communicate with (such as via an A1 interface) the near-RT RIC 325. The near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as the O-eNB 311, with the near-RT RIC 325.

In some implementations, to generate AI/ML models to be deployed in the near-RT RIC 325, the non-RT RIC 315 may receive parameters or external enrichment information from external servers. Such information may be utilized by the near-RT RIC 325 and may be received at the SMO framework 305 or the non-RT RIC 315 from non-network data sources or from network functions. In some examples, the non-RT RIC 315 or the near-RT RIC 325 may be configured to tune RAN behavior or performance. For example, the non-RT RIC 315 may monitor long-term trends and patterns for performance and employ AI/ML models to perform corrective actions through the SMO framework 305 (such as reconfiguration via O1) or via creation of RAN management policies (such as A1 policies).

In wireless communication networks, a paging message may notify a UE of an incoming call, a message, or other data while the UE is in an idle or inactive state. To conserve battery power, the UE may use a discontinuous reception (DRX) technique to cycle between low-power sleep states and brief wake periods. The UE may check for paging messages during the wake periods. Each paging message may be sent during a respective paging occasion of one or more paging occasions within a paging frame. Each paging frame corresponds to a single radio frame.

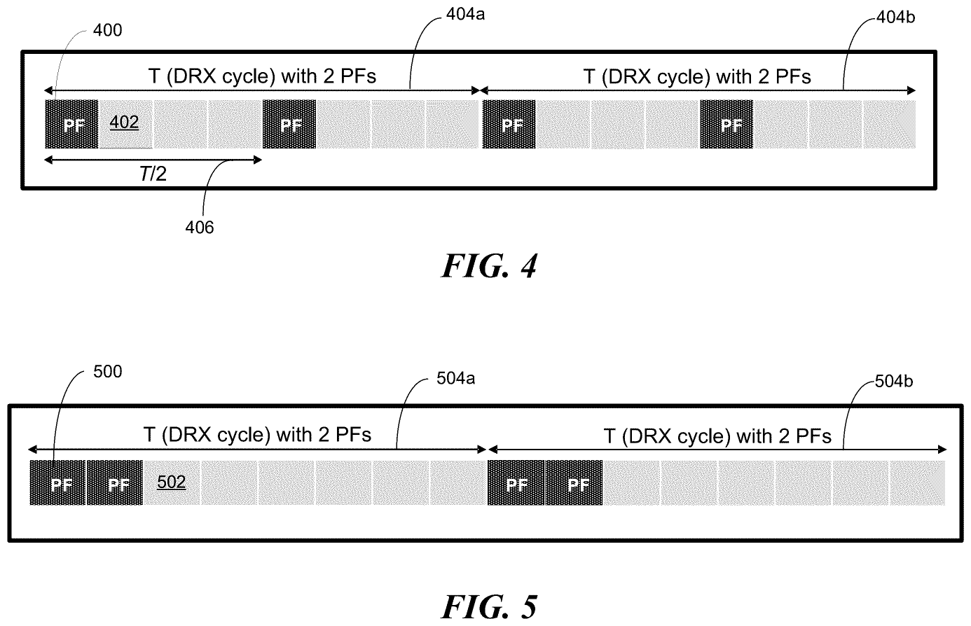

FIG. 4 is a block diagram illustrating an example of a Rel-18 paging frame configuration, in accordance with various aspects of the present disclosure. FIG. 4 illustrates two DRX cycles 404a and 404b. Respective paging frames 400 within each DRX cycle 404a and 404b may be uniformly distributed at intervals 406 of TIN, where T represents a length (for example, a quantity of frames) of the DRX cycle 404a and 404b and N represents a quantity of paging frames (PFs) 400 allocated to the DRX cycle 404a and 404b. The interval TIN may be an example of a paging frame interval. A UE may wake up at each PF 400 and sleep at each non-PF radio frame 402 between PFs 400. For ease of explanation, only one PF 400 and one non-PF radio frame 402 are labeled in the example of FIG. 4.

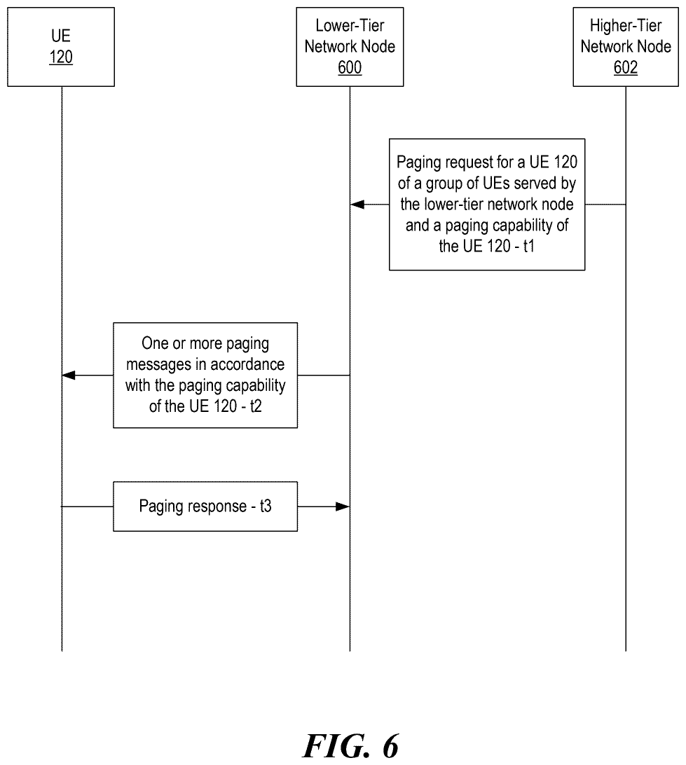

In some other wireless communication systems, such as Rel-19 systems and beyond, adaptive paging may be enabled for one or more cells associated with a network node. FIG. 5 is a block diagram illustrating an example of adaptive paging, in accordance with various aspects of the present disclosure. FIG. 5 illustrates two DRX cycles 504a and 504b. In such examples, when adaptive paging is enabled, the network node may allocate PFs 500 within each DRX cycle 504a and 504b, irrespective of a paging frame interval. Specifically, in such examples, the network node may schedule the paging frames, such that paging occasions align with a cell's DTX cycle. Aligning paging occasions with the DTX cycle reduces network overhead because the network node does not need to schedule the paging messages for all UEs in the cell within the same paging frame. In the example of FIG. 5, the UE may wake up at each PF 500 and sleep at each non-PF radio frame 502. For ease of explanation, only one PF 500 and non-PF radio frame 502 are labeled in the example of FIG. 5.

A wireless communication network may include different tiers of network nodes. For example, the wireless communication network may include higher-tier network nodes and lower-tier network nodes. Paging for a UE is initiated by a higher-tier network node, such as a central unit (CU) or an access and mobility management function (AMF). This higher-tier network node sends the paging request to a lower-tier network node, such as a distributed unit (DU), a base station (for example, gNodeB (gNB)), or a neighboring node. The lower-tier network node may transmit one or more paging messages to a UE in accordance with receiving the paging request from the higher-tier network node. Lower-tier network nodes do not store detailed capability information about UEs. This capability information may indicate whether a UE is a Rel-18 capable UE or a Rel-19 capable UE. In the present application, higher-tier network nodes may also be referred to as higher-tier nodes (hereinafter used interchangeably), and lower-tier network nodes may also be referred to as lower-tier nodes (hereinafter used interchangeably).

When a lower-tier network node has activated Rel-19 features, such as paging adaptation, the lower-tier network node does not know if a served UE is capable of supporting the activated Rel-19 features. For example, the lower-tier network node may be unaware if a UE that is being paged is a Rel-18 capable UE or a Rel-19 capable UE, which can take advantage of the paging adaptation. In such an example, without knowing the UE's capability, the lower-tier network node cannot determine whether to use a Rel-19 paging frame configuration or a Rel-18 paging frame configuration. This uncertainty can lead to ineffective paging operations because the lower-tier network node may use an incorrect paging configuration when paging one or more UEs.

Various aspects of the present disclosure are directed to a higher-tier network node indicating UE capability to a lower-tier network node. The UE capability may be used by the lower-tier network node to adapt signaling to one or more UEs served by the lower-tier network node. The UE capability may indicate, for example, whether the UE is a Rel-18 capable UE or a Rel-19 capable UE. Additionally, or alternatively, based on the UE capability, the lower-tier network node may determine one or more of a type of paging configuration supported by the UE, whether the UE supports random access channel (RACH) occasion (RO) adaptation, whether the UE supports a paging early indication, or other features, such as new energy saving (NES) features.

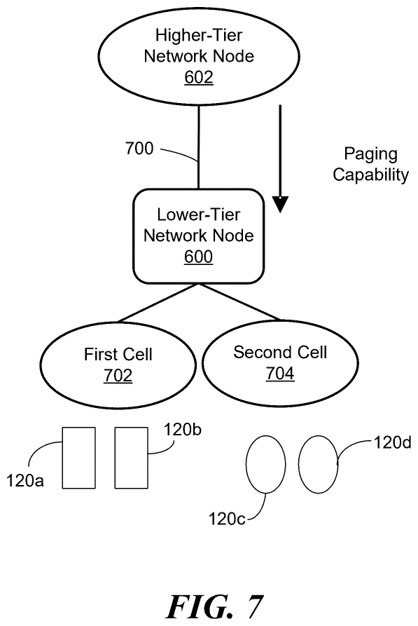

FIG. 6 is a timing diagram illustrating an example of a higher-tier network node 602 indicating UE capability information to a lower-tier network node 600, in accordance with various aspects of the present disclosure. In the example of FIG. 6, the higher-tier network node 602 may be an example of a core network 130 described with reference to FIG. 1, or a CU 310 or a core network 320 described with reference to FIG. 3. The lower-tier network node 600 may be an example of a base station 110 described with reference to FIGS. 1 and 2, or a DU 330 or RU 340 described with reference to FIG. 3. In the example of FIG. 6, at time t1, the lower-tier network node 600 receives, from a higher-tier network node 602, a first message indicating a paging request for a first UE 120 of a group of UEs served by the lower-tier network node 600 and a paging capability of the first UE 120. The paging capability may be associated with either a Rel-19 paging frame configuration that distributes one or more paging frames within a DRX cycle, irrespective of a paging frame interval or a Rel-18 paging frame configuration that uniformly distributes the one or more paging frames within the DRX cycle in accordance with the paging frame interval. In other examples, the higher-tier network node 602 may indicate the UE capability to a neighboring lower-tier network node (not shown in the example of FIG. 6). The first message may be received via a next generation (NG) interface, an F1 interface, an Xn interface, or another type of interface.

At time t2, in accordance with receiving the first message, the lower-tier network node 600 transmits, to the UE 120, one or more paging messages in accordance with the paging capability of the UE 120. In some examples, the lower-tier network node 600 transmits the one or more paging messages to the UE 120 in accordance with the paging capability of the UE 120 when the lower-tier network node 600 enables the Rel-19 paging frame configuration (for example, paging adaptation). In some other examples, the lower-tier network node 600 transmits the one or more paging messages to the UE 120 in accordance with only the Rel-18 paging configuration when the lower-tier network node 600 disables the Rel-19 paging frame configuration. At time t3, in response to transmitting the one or more paging messages, the lower-tier network node 600 receives, from the UE 120, a paging response.

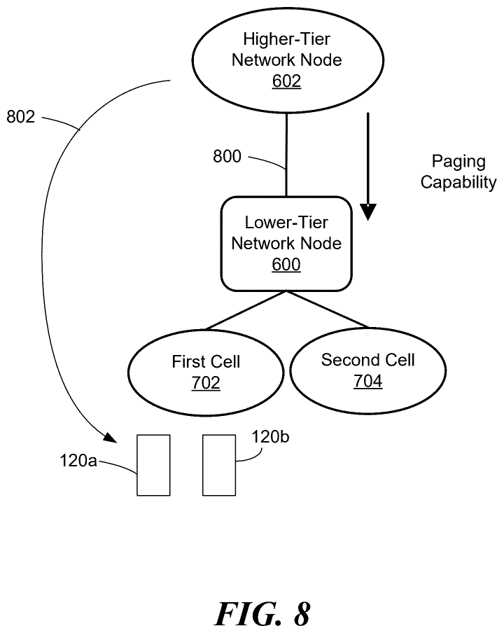

In some examples, paging adaptation is not useful if there are no Rel-19 UEs within a coverage area of a network node or if a quantity of Rel-19 UEs is less than a threshold. Additionally, lower-tier network nodes may be unaware of a quantity of Rel-19 UEs (for example, idle or inactive UEs within their coverage area). FIG. 7 is a block diagram illustrating an example of a network layout, in accordance with various aspects of the present disclosure. In the example of FIG. 7, a higher-tier network node 602 may communicate with a lower-tier network node 600 via an interface 700, such as an NG interface, an F1 interface, an Xn interface, or another type of interface. In the example of FIG. 7, based on its knowledge of the capability of each idle/inactive UE 120a, 120b, 120c, 120d, the higher-tier network node 602 may indicate to the lower-tier network node 600, or a neighboring lower-tier network node, a message indicating a quantity of UEs, of the group of UEs 120a, 120b, 120c, 120d, having a specific capability, such as a respective paging capability associated with the Rel-19 paging frame configuration. Alternatively, the higher-tier network node 602 may indicate a paging capability of an average population of the group of UEs 120a, 120b, 120c, and 120d. In the example of FIG. 7, first and second UEs 120a and 120b may be associated with the Rel-19 paging frame configuration, and third and fourth UEs 120c and 120d may be associated with the Rel-18 paging frame configuration.

In some examples, the lower-tier network node 600 may enable the paging adaptation in accordance with the Rel-19 paging frame configuration satisfying a paging adaptation condition. For example, the paging adaptation may be enabled if the quantity of UEs associated with the Rel-19 paging frame configuration is greater than a paging adaption threshold. In the example of FIG. 7, the lower-tier network node 600 may enable the paging adaptation for a first cell 702 and may disable paging adaptation for a second cell 704 because no UEs are associated with the Rel-19 paging frame configuration in the second cell 704.

In some other examples, rather than indicating a quantity of idle/inactive UEs with a specific UE capability, the higher-tier network node 602 may enable or disable a specific feature, such as paging adaptation within a coverage area. For example, the coverage area may be associated with one or more cells (for example, the first cell 702 and/or the second cell 704), a tracking area (TA) identifier (ID), or a radio access network area code (RANAC) ID. As discussed, the UE capability is not limited to a UE paging capability. In addition to, or alternate from, the paging capability, the UE capability may include RO adaptation, paging early indication, or other NES capabilities.

In some examples, only UEs that are both capable of and authorized to use an enhanced feature, such as a Rel-19 paging frame configuration, can benefit from such a feature. In such examples, a higher-tier network may grant specific authorization to a subset of UEs, such as a subset of Rel-19 capable UEs, that are idle or inactive. These authorized UEs can then use extra paging occasions in accordance with the Rel-19 paging frame configuration. In such examples, the authorized UEs benefit from reduced overhead, and fewer missed paging messages compared to UEs that monitor for paging messages on conventional paging occasions. This selective paging adaptation provides special treatment to these authorized UEs. For example, selective paging adaptation may be an incentive for UEs that provide assistance information to the network.

FIG. 8 is a block diagram illustrating an example of a network layout, in accordance with various aspects of the present disclosure. In the example of FIG. 8, a higher-tier network node 602 may communicate with a lower-tier network node 600 via an interface 800, such as an NG interface, an F1 interface, an Xn interface, or another type of interface. In the example of FIG. 8, the higher-tier network node 602 may have knowledge of a capability of each idle/inactive UE 120a and 120b based on information provided by each UE 120a and 120b when the respective UEs 120a and 120b initiated a connection with the lower-tier network node 600. For example, each UE 120a and 120b may be a Rel-19 capable UE. As such, the paging capability of both UEs 120a and 120b is for the Rel-19 paging frame configuration.

In the example of FIG. 8, a first UE 120a may receive, in accordance with the paging capability for the Rel-19 paging frame configuration, a message indicating an authorization for the first UE 120a to receive one or more paging messages in accordance with the Rel-19 paging frame configuration. The message may be an RRC message. In other examples, the message may be a non-access stratum (NAS) message 802. In yet other examples, the message may be a user plane message. In still other examples, the message may be a system information message. In some such examples, the authorization may be associated with a UE class associated with the first UE 120a or a UE category associated with the first UE 120a. In other such examples, the system information message indicates whether the authorization applies to a current cell (for example, a first cell 702) associated with the first UE 120a and/or whether the lower-tier network node 600 can selectively override the authorization. In still other examples, the system information message may indicate whether the Rel-19 paging frame configuration is enabled for all UEs within a cell having a respective paging capability associated with the Rel-19 paging frame configuration or the Rel-19 paging frame configuration is only enabled for one or more UEs within the cell authorized to use the Rel-19 paging configuration.

After receiving the message, the first UE 120a receives, from the lower-tier network node 600 one or more paging messages in accordance with the Rel-19 paging frame configuration. The second UE 120b may not be authorized to receive one or more paging messages in accordance with the Rel-19 paging frame configuration. Therefore, the second UE 120b may only receive paging messages in accordance with the Rel-18 paging frame configuration. Additionally, in some examples, a message, such as a paging request from the higher-tier network node 602 to the lower-tier network node 600, may include an indication of whether a UE is authorized to use enhanced features, such as the Rel-19 paging frame configuration. The authorization is not limited to authorizing UEs to use the Rel-19 paging frame configuration. The authorization may authorize UEs to use any enhanced features, such as, but not limited to, RO adaptation, paging early indication, or NES capabilities.

In some cases, a UE may be barred from accessing a specific cell. In such cases, barring the UE may cause inefficiencies in the paging process. For example, if the CU receives a paging request for the UE from the AMF without knowing that the UE is barred from a cell, the CU might still attempt to page the UE in the cell. This is particularly wasteful if the cell is a new energy-saving (NES) cell, which is designed to conserve energy.

In some examples, the AMF provides the CU with assistance information about the UE's supported features and capabilities. This information can be an extension of a paging information element, such as UERadioPagingInformation. Based on this data, the CU can make an informed decision about which cells are appropriate for paging the UE. This technique may be extended to RAN paging, where one CU (for example, CU1) shares this information with another CU (for example, CU2) to improve the paging process across multiple cells.

In other examples, the CU shares the barred status of its cells with the AMF. With this knowledge, the AMF can consider the UE's capabilities and the status of various cells to recommend a list of cells suitable for paging. This approach may use existing techniques, such as assistance data for a recommended cell legacy feature. This solution can also be applied to RAN paging.

In some examples, legacy UEs or UEs that do not support Rel-18 NES features (such as cell DTX/DRX) may be barred from accessing a Rel-18 NES cell. This is indicated by a cellBarredNES information element in system information block 1 (SIB1). Additionally, legacy UEs or those that do not support Rel-19 NES features (such as On-Demand SIB1, PRACH adaptation, and/or paging adaptation) may be barred from accessing a Rel-19 NES cell.

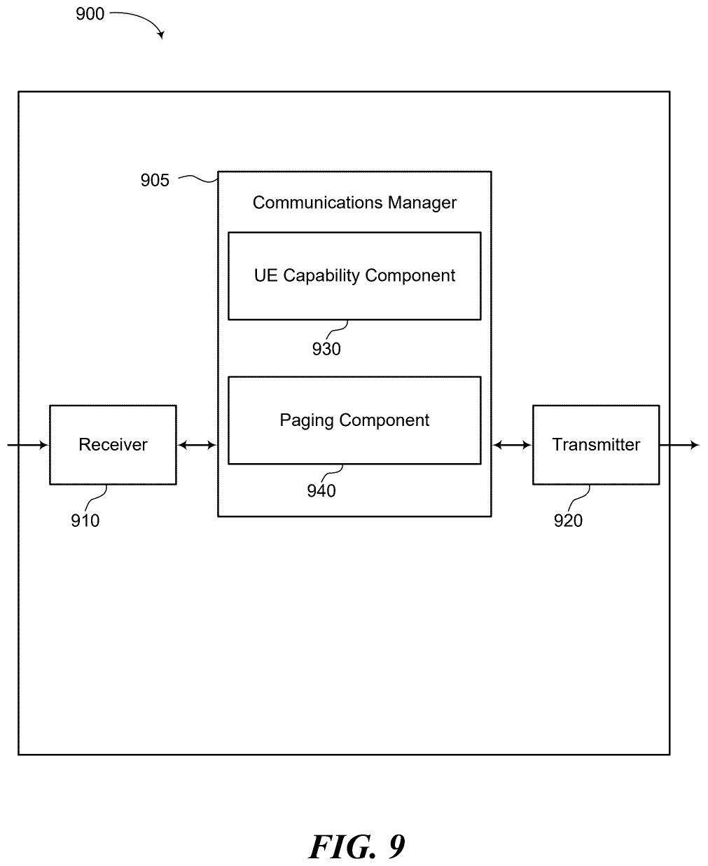

FIG. 9 is a block diagram illustrating an example wireless communication device 900 that supports adapting signaling based on a UE capability, in accordance with various aspects of the present disclosure. The wireless communication device 900 may be an example of aspects of a lower-tier network node 600 described with respect to FIGS. 6, 7, and 8. The wireless communication device 900 may include a receiver 910, a communications manager 905, a transmitter 920, a UE capability component 930, and a paging component 940, which may be in communication with one another (for example, via one or more buses). In some examples, the wireless communication device 900 is configured to perform operations, including operations of the process 1000 described below with reference to FIG. 10.

In some examples, the wireless communication device 900 can include a chip, chipset, package, or device that includes at least one processor and at least one modem (for example, a 5G modem or other cellular modem). In some examples, the communications manager 905, or its sub-components, may be separate and distinct components. In some examples, at least some components of the communications manager 905 are implemented at least in part as software stored in a memory. For example, portions of one or more of the components of the communications manager 905 can be implemented as non-transitory code executable by the processor to perform the functions or operations of the respective component.

The receiver 910 may receive one or more of reference signals (for example, periodically configured CSI-RSs, aperiodically configured CSI-RSs, or multi-beam-specific reference signals), synchronization signals (for example, synchronization signal blocks (SSBs)), control information and data information, such as in the form of packets, from one or more other wireless communication devices via various channels including control channels (for example, a physical downlink control channel (PDCCH) or physical shared control channel (PSCCH)) and data channels (for example, a physical downlink shared channel (PDSCH) or physical shared sidelink channel (PSSCH)). The other wireless communication devices may include, but are not limited to, a core network 130 described with reference to FIG. 1, a core network 320 or a CU 310 described with reference to FIG. 3.

The received information may be passed on to other components of the wireless communication device 900. The receiver 910 may be an example of aspects of the receive processor 238 described with reference to FIG. 2. The receiver 910 may include a set of radio frequency (RF) chains that are coupled with or otherwise utilize a set of antennas (for example, the set of antennas may be an example of aspects of the antennas 234 described with reference to FIG. 2).

The transmitter 920 may transmit signals generated by the communications manager 905 or other components of the wireless communication device 900. In some examples, the transmitter 920 may be collocated with the receiver 910 in a transceiver. The transmitter 920 may be an example of aspects of the transmit processor 220 described with reference to FIG. 2. The transmitter 920 may be coupled with or otherwise utilize a set of antennas (for example, the set of antennas may be an example of aspects of the antennas 234 described with reference to FIG. 2), which may be antenna elements shared with the receiver 910. In some examples, the transmitter 920 is configured to transmit control information in a PSCCH or PDCCH and data in a physical PSSCH or PDSCH.

The communications manager 905 may be an example of aspects of the controller/processor 240 described with reference to FIG. 2. The communications manager 905 may include the UE capability component 930 and a paging component 940. In some examples, working in conjunction with the receiver 910, the UE capability component 930 receives, from a higher-tier network node, a first message indicating a paging request for a first UE of a group of UEs served by the lower-tier network node and a paging capability of the first UE. The paging capability may be associated with either a first paging frame configuration that distributes one or more paging frames within a DRX cycle, irrespective of a paging frame interval or a second paging frame configuration that uniformly distributes the one or more paging frames within the DRX cycle in accordance with the paging frame interval. Additionally, working in conjunction with the transmitter 920 and/or the UE capability component 930, the paging component 940 transmits, to the first UE in accordance with receiving the first message, one or more paging messages in accordance with the paging capability of the first UE. Finally, working in conjunction with the receiver 910, the paging component 940 receives, from the first UE, a paging response in accordance with transmitting the one or more paging messages.

FIG. 10 is a flow diagram illustrating an example of a process 1000 for adapting signaling in accordance with a UE's capability, in accordance with various aspects of the present disclosure. The process 1000 may be performed by a device lower-tier network node, such as a lower-tier network node 600 described with respect to FIGS. 6, 7, and 8. The example process 1000 begins at block 1002 by receiving, from a higher-tier network node, a first message indicating a paging request for a first UE of a group of UEs served by the lower-tier network node and a paging capability of the first UE. The paging capability may be associated with either a first paging frame configuration that distributes one or more paging frames within a DRX cycle, irrespective of a paging frame interval or a second paging frame configuration that uniformly distributes the one or more paging frames within the DRX cycle in accordance with the paging frame interval. At block 1004, the process 1000 transmits, to the first UE in accordance with receiving the first message, one or more paging messages in accordance with the paging capability of the first UE. Additionally, at block 1006, the process 1000 receives, from the first UE, a paging response in accordance with transmitting the one or more paging messages.

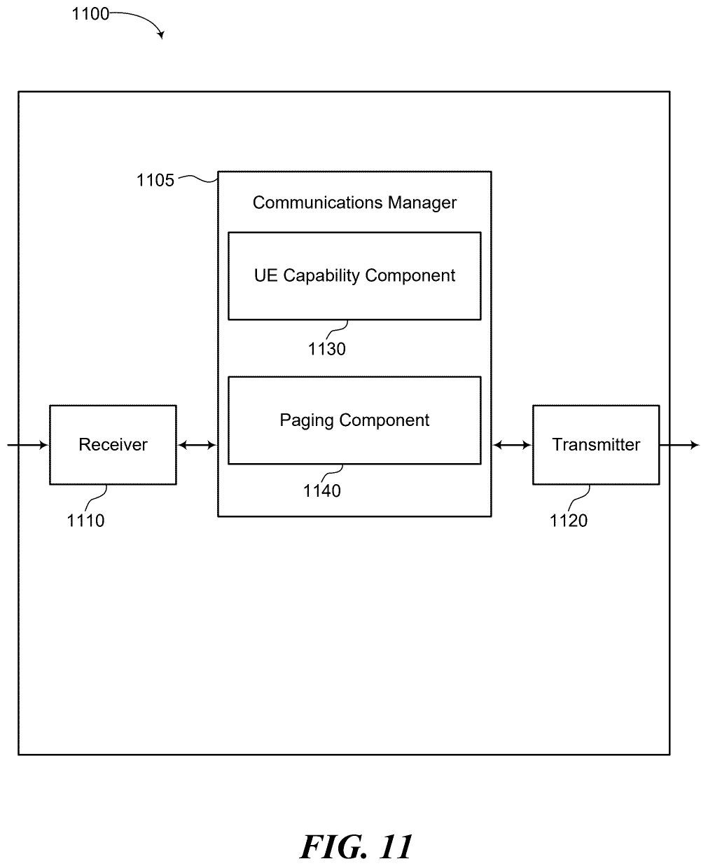

FIG. 11 is a block diagram illustrating an example wireless communication device 1100 that supports adaptive signaling in accordance with a UE capability, in accordance with various aspects of the present disclosure. The wireless communication device 1100 may be an example of aspects of a UE 120 described with respect to FIGS. 1, 2, 3, 6, 7, and 8. The wireless communication device 1100 may include a receiver 1110, a communications manager 1105, a transmitter 1120, a UE capability component 1130, and a paging component 1140, which may be in communication with one another (for example, via one or more buses). In some examples, the wireless communication device 1100 is configured to perform operations, including operations of the process 1200 described below with reference to FIG. 12.

In some examples, the wireless communication device 1100 can include a chip, chipset, package, or device that includes at least one processor and at least one modem (for example, a 5G modem or other cellular modem). In some examples, the communications manager 1105, or its sub-components, may be separate and distinct components. In some examples, at least some components of the communications manager 1105 are implemented at least in part as software stored in a memory. For example, portions of one or more of the components of the communications manager 1105 can be implemented as non-transitory code executable by the processor to perform the functions or operations of the respective component.

The receiver 1110 may receive one or more of reference signals (for example, periodically configured channel state information-reference signals (CSI-RSs), aperiodically configured CSI-RSs, or multi-beam-specific reference signals), synchronization signals (for example, synchronization signal blocks (SSBs)), control information and data information, such as in the form of packets, from one or more other wireless communication devices via various channels including control channels (for example, a physical downlink control channel (PDCCH), or physical shared control channel (PSCCH)) and data channels (for example, a PDSCH, PSSCH). The other wireless communication devices may include, but are not limited to, a base station 110 described with reference to FIGS. 1 and 2, a DU 330, an RU 340, or a CU 310 described with reference to FIG. 3, a lower-tier network node 600 described with reference to FIGS. 6, 7, and 8, or a higher-tier network node 602 described with reference to FIGS. 6, 7, and 8.

The received information may be passed on to other components of the wireless communication device 1100. The receiver 1110 may be an example of aspects of the receive processor 258 described with reference to FIG. 2. The receiver 1110 may include a set of radio frequency (RF) chains that are coupled with or otherwise utilize a set of antennas (for example, the set of antennas may be an example of aspects of the antennas 252 described with reference to FIG. 2).

The transmitter 1120 may transmit signals generated by the communications manager 1105 or other components of the wireless communication device 1100. In some examples, the transmitter 1120 may be collocated with the receiver 1110 in a transceiver. The transmitter 1120 may be an example of aspects of the transmit processor 264 described with reference to FIG. 2. The transmitter 1120 may be coupled with or otherwise utilize a set of antennas (for example, the set of antennas may be an example of aspects of the antennas 252 described with reference to FIG. 2), which may be antenna elements shared with the receiver 1110. In some examples, the transmitter 1120 is configured to transmit control information in a physical uplink control channel (PUCCH) or PSCCH, and data in a physical uplink shared channel (PUSCH) or PSSCH.

The communications manager 1105 may be an example of aspects of the controller/processor 280 described with reference to FIG. 2. The communications manager 1105 may include the UE capability component 1130, and the paging component 1140. In some examples, working in conjunction with the transmitter 1120, the UE capability component 1130 transmits, to a network node, a first message indicating a paging capability of the UE. The paging capability may be either a first paging frame configuration that distributes one or more paging frames within a DRX cycle irrespective of a paging frame interval or a second paging frame configuration that uniformly distributes the one or more paging frames within the DRX cycle in accordance with the paging frame interval. At block 1204, the process 1200 receives, in accordance with the paging capability being associated with the first paging frame configuration, a second message indicating an authorization for the UE to receive one or more paging messages in accordance with the first paging frame configuration. Furthermore, at block 1206, the process 1200 receives, from the network node in accordance with receiving the second message, the one or more paging messages in accordance with the first paging frame configuration.

FIG. 12 is a flow diagram illustrating an example of a process 1200 for adapting signaling in accordance with a UE's capability, in accordance with various aspects of the present disclosure. The process 1200 may be performed by a UE, such as a UE 120 described with reference to FIGS. 1, 2, 3, 5, 6, 7, and 8. The example process 1200 begins at block 1202 by transmitting, to a network node, a first message indicating a paging capability of the UE. The paging capability may be either a first paging frame configuration that distributes one or more paging frames within a DRX cycle irrespective of a paging frame interval or a second paging frame configuration that uniformly distributes the one or more paging frames within the DRX cycle in accordance with the paging frame interval. At block 1204, the process 1200 receives, in accordance with the paging capability being associated with the first paging frame configuration, a second message indicating an authorization for the UE to receive one or more paging messages in accordance with the first paging frame configuration. Furthermore, at block 1206, the process 1200 receives, from the network node in accordance with receiving the second message, the one or more paging messages in accordance with the first paging frame configuration.

Implementation examples are described in the following numbered clauses:
Clause 1. A method for wireless communication at a lower-tier network node, comprising: receiving, from a higher-tier network node, a first message indicating a paging request for a first UE of a group of UEs served by the lower-tier network node and a paging capability of the first UE, the paging capability being associated with either a first paging frame configuration that distributes one or more paging frames within a DRX cycle, irrespective of a paging frame interval or a second paging frame configuration that uniformly distributes the one or more paging frames within the DRX cycle in accordance with the paging frame interval; transmitting, to the first UE in accordance with receiving the first message, one or more paging messages in accordance with the paging capability of the first UE; and receiving, from the first UE, a paging response in accordance with transmitting the one or more paging messages.
Clause 2. The method of Clause 1, wherein: the lower-tier network node transmits respective paging messages to one or more UEs of the group of UEs in accordance with a respective paging capability of each UE of the one or more UEs, in accordance with enabling the first paging frame configuration at the lower-tier network node; and the lower-tier network node transmits respective paging messages to the one or more UEs of the group of UEs in accordance with only the second paging configuration in accordance with disabling the first paging frame configuration at the lower-tier network node.
Clause 3. The method of Clause 2, further comprising: receiving, from the higher-tier network node, a second message indicating a quantity of UEs, of the group of UEs, having the respective paging capability associated with the first paging frame configuration; enabling the first paging frame configuration at the lower-tier network node in accordance with the quantity of UEs satisfying a paging adaptation condition; and transmitting, to the higher-tier network node, a third message indicating the first paging frame configuration is enabled.
Clause 4. The method of Clause 3, wherein the paging adaptation condition is satisfied in accordance with the quantity of UEs being greater than a paging adaption threshold.
Clause 5. The method of Clause 2, further comprising receiving, from the higher-tier network node, a second message indicating whether the first paging frame configuration is enabled or disabled within a coverage area, wherein the coverage area is associated with one or more cells, a TA ID, or a RANAC ID.
Clause 6. The method of any one of Clauses 1-5, wherein the higher-tier network node is a core network device or a central unit device and the lower-tier network node is a base station or a distributed unit device.
Clause 7. The method of any one of Clauses 1-6, wherein the first message is received via an NG interface, an F1 interface, or an Xn interface.
Clause 8. The method of Clause 1, further comprising transmitting, to the first UE prior to transmitting the one or more paging messages, a third message indicating an authorization for the first UE to receive the one or more paging messages in accordance with the first paging frame configuration, wherein the third message is an RRC message or a system information message.
Clause 9. The method of any one of Clauses 1-8, wherein the paging request is a cell specific paging request in accordance with at least the paging capability of the first UE.
Clause 10. The method of any one of Clauses 1-8, wherein the paging request is received in accordance with the first UE being within a cell that is included in a list of cells for paging.
Clause 11. The method of claim 1, further comprising: receiving, from the higher-tier network node, a second message indicating a capability of one or more UEs of the group of UEs to support one or more of RO adaptation, a paging early indication, or NES; and adapting one or more signals, for the one or more UEs, in accordance with the capability of the one or more UEs to support one or more of the RO adaptation, the paging early indication, or the NES.
Clause 12. A method for wireless communication at a UE, comprising: transmitting, to a network node, a first message indicating a paging capability of the UE, the paging capability being either a first paging frame configuration that distributes one or more paging frames within a DRX cycle irrespective of a paging frame interval or a second paging frame configuration that uniformly distributes the one or more paging frames within the DRX cycle in accordance with the paging frame interval; receiving, in accordance with the paging capability being associated with the first paging frame configuration, a second message indicating an authorization for the UE to receive one or more paging messages in accordance with the first paging frame configuration; and receiving, from the network node in accordance with receiving the second message, the one or more paging messages in accordance with the first paging frame configuration.
Clause 13. The method of Clause 12, wherein the second message is a radio resource control message, a non-access stratum message, or a user plane message.
Clause 14. The method of any one of Clauses 12-13, wherein: the second message is a system information message; and the authorization is associated with a UE class corresponding to the UE or a UE category corresponding to the UE.
Clause 15. The method of any one of Clauses 12-14, further comprising receiving, from the network node, a system information message indicating whether the authorization applies to a current cell associated with the UE and/or whether the network node can selectively override the authorization.
Clause 16. The method of any one of Clauses 12-15, further comprising receiving, from the network node, a system information message indicating the first paging frame configuration is enabled for all UEs within a cell having a respective paging capability associated with the first paging frame configuration or the first paging frame configuration is only enabled for one or more UEs within the cell authorized to use the first paging configuration.
Clause 17. An apparatus comprising a processor, memory coupled with the processor, and instructions stored in the memory and operable, when executed by the processor to cause the apparatus to perform any one of Clauses 1-12.
Clause 18. An apparatus comprising at least one means for performing any one of Clauses 1-12.
Clause 19. A computer program comprising code for causing an apparatus to perform any one of Clauses 1-12.
Clause 20. An apparatus comprising a processor, memory coupled with the processor, and instructions stored in the memory and operable, when executed by the processor to cause the apparatus to perform any one of Clauses 13-16.
Clause 21. An apparatus comprising at least one means for performing any one of Clauses 13-16.
Clause 22. A computer program comprising code for causing an apparatus to perform any one of Clauses 13-16.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (for example, a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (for example, related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method for wireless communication at a lower-tier network node, comprising:
receiving, from a higher-tier network node, a first message indicating a paging request for a first user equipment (UE) of a group of UEs served by the lower-tier network node and a paging capability of the first UE, the paging capability being associated with either a first paging frame configuration that distributes one or more paging frames within a discontinuous reception (DRX) cycle, irrespective of a paging frame interval or a second paging frame configuration that uniformly distributes the one or more paging frames within the DRX cycle in accordance with the paging frame interval;
transmitting, to the first UE in accordance with receiving the first message, one or more paging messages in accordance with the paging capability of the first UE; and
receiving, from the first UE, a paging response in accordance with transmitting the one or more paging messages.

2. The method of claim 1, wherein:
respective paging messages are transmitted to one or more UEs of the group of UEs in accordance with a respective paging capability of each UE of the one or more UEs, in accordance with enabling the first paging frame configuration at the lower-tier network node; and
respective paging messages are transmitted to the one or more UEs of the group of UEs in accordance with only the second paging configuration in accordance with disabling the first paging frame configuration at the lower-tier network node.

3. The method of claim 2, further comprising:
receiving, from the higher-tier network node, a second message indicating a quantity of UEs, of the group of UEs, having the respective paging capability associated with the first paging frame configuration;
enabling the first paging frame configuration at the lower-tier network node in accordance with the quantity of UEs satisfying a paging adaptation condition; and
transmitting, to the higher-tier network node, a third message indicating the first paging frame configuration is enabled.

4. The method of claim 3, wherein the paging adaptation condition is satisfied in accordance with the quantity of UEs being greater than a paging adaption threshold.

5. The method of claim 2, further comprising receiving, from the higher-tier network node, a second message indicating whether the first paging frame configuration is enabled or disabled within a coverage area, wherein the coverage area is associated with one or more cells, a tracking area (TA) identifier (ID), or a radio access network area code (RANAC) ID.

6. The method of claim 1, wherein the higher-tier network node is a core network device or a central unit device and the lower-tier network node is a base station or a distributed unit device.

7. The method of claim 1, wherein the first message is received via a next generation (NG) interface, an F1 interface, or an Xn interface.

8. The method of claim 1, further comprising transmitting, to the first UE prior to transmitting the one or more paging messages, a third message indicating an authorization for the first UE to receive the one or more paging messages in accordance with the first paging frame configuration, wherein the third message is a radio resource control (RRC) message or a system information message.

9. The method of claim 1, wherein the paging request is a cell specific paging request in accordance with at least the paging capability of the first UE.

10. The method of claim 1, wherein the paging request is received in accordance with the first UE being within a cell that is included in a list of cells for paging.

11. The method of claim 1, further comprising:
receiving, from the higher-tier network node, a second message indicating a capability of one or more UEs of the group of UEs to support one or more of random access channel (RACH) occasion (RO) adaptation, a paging early indication, or new energy saving (NES); and
adapting one or more signals, for the one or more UEs, in accordance with the capability of the one or more UEs to support one or more of the RO adaptation, the paging early indication, or the NES.

12. A lower-tier network node, comprising:
one or more processors; and
one or more memories coupled with the one or more processors and storing processor-executable code that, when executed by the one or more processors, is configured to cause the lower-tier network node to:
receive, from a higher-tier network node, a first message indicating a paging request for a first user equipment (UE) of a group of UEs served by the lower-tier network node and a paging capability of the first UE, the paging capability being associated with either a first paging frame configuration that distributes one or more paging frames within a discontinuous reception (DRX) cycle, irrespective of a paging frame interval or a second paging frame configuration that uniformly distributes the one or more paging frames within the DRX cycle in accordance with the paging frame interval;
transmit, to the first UE in accordance with receiving the first message, one or more paging messages in accordance with the paging capability of the first UE; and
receive, from the first UE, a paging response in accordance with transmitting the one or more paging messages.

13. The lower-tier network node of claim 12, wherein:
respective paging messages are transmitted to one or more UEs of the group of UEs in accordance with a respective paging capability of each UE of the one or more UEs, in accordance with enabling the first paging frame configuration at the lower-tier network node; and
respective paging messages are transmitted to the one or more UEs of the group of UEs in accordance with only the second paging configuration in accordance with disabling the first paging frame configuration at the lower-tier network node.

14. The lower-tier network node of claim 13, wherein execution of the processor-executable code further causes the UE to:
receive, from the higher-tier network node, a second message indicating a quantity of UEs, of the group of UEs, having the respective paging capability associated with the first paging frame configuration;
enable the first paging frame configuration at the lower-tier network node in accordance with the quantity of UEs satisfying a paging adaptation condition; and
transmit, to the higher-tier network node, a third message indicating the first paging frame configuration is enabled.

15. The lower-tier network node of claim 14, wherein the paging adaptation condition is satisfied in accordance with the quantity of UEs being greater than a paging adaption threshold.

16. The lower-tier network node of claim 13, wherein execution of the processor-executable code further causes the UE to receive, from the higher-tier network node, a second message indicating whether the first paging frame configuration is enabled or disabled within a coverage area, wherein the coverage area is associated with one or more cells, a tracking area (TA) identifier (ID), or a radio access network area code (RANAC) ID.

17. The lower-tier network node of claim 12, wherein the higher-tier network node is a core network device or a central unit device and the lower-tier network node is a base station or a distributed unit device.

18. The lower-tier network node of claim 12, wherein the first message is received via a next generation (NG) interface, an F1 interface, or an Xn interface.

19. The lower-tier network node of claim 12, wherein execution of the processor-executable code further causes the UE to transmit, to the first UE prior to transmitting the one or more paging messages, a third message indicating an authorization for the first UE to receive the one or more paging messages in accordance with the first paging frame configuration, wherein the third message is a radio resource control (RRC) message or a system information message.

20. The lower-tier network node of claim 12, wherein execution of the processor-executable code further causes the lower-tier network node to:
receive, from the higher-tier network node, a second message indicating a capability of one or more UEs of the group of UEs to support one or more of random access channel (RACH) occasion (RO) adaptation, a paging early indication, or new energy saving (NES); and
adapt one or more signals, for the one or more UEs, in accordance with the capability of the one or more UEs to support one or more of the RO adaptation, the paging early indication, or the NES.

21. A method for wireless communication at a user equipment (UE), comprising:
transmitting, to a network node, a first message indicating a paging capability of the UE, the paging capability being either a first paging frame configuration that distributes one or more paging frames within a discontinuous reception (DRX) cycle irrespective of a paging frame interval or a second paging frame configuration that uniformly distributes the one or more paging frames within the DRX cycle in accordance with the paging frame interval;
receiving, in accordance with the paging capability being associated with the first paging frame configuration, a second message indicating an authorization for the UE to receive one or more paging messages in accordance with the first paging frame configuration; and
receiving, from the network node in accordance with receiving the second message, the one or more paging messages in accordance with the first paging frame configuration.

22. The method of claim 21, wherein the second message is a radio resource control message, a non-access stratum message, or a user plane message.

23. The method of claim 21, wherein:
the second message is a system information message; and
the authorization is associated with a UE class corresponding to the UE or a UE category corresponding to the UE.

24. The method of claim 21, further comprising receiving, from the network node, a system information message indicating whether the authorization applies to a current cell associated with the UE and/or whether the network node can selectively override the authorization.

25. The method of claim 21, further comprising receiving, from the network node, a system information message indicating the first paging frame configuration is enabled for all UEs within a cell having a respective paging capability associated with the first paging frame configuration or the first paging frame configuration is only enabled for one or more UEs within the cell authorized to use the first paging configuration.

26. A user equipment (UE) comprising:
one or more processors; and
one or more memories coupled with the one or more processors and storing processor-executable code that, when executed by the one or more processors, is configured to cause the UE to:
transmit, to a network node, a first message indicating a paging capability of the UE, the paging capability being either a first paging frame configuration that distributes one or more paging frames within a discontinuous reception (DRX) cycle irrespective of a paging frame interval or a second paging frame configuration that uniformly distributes the one or more paging frames within the DRX cycle in accordance with the paging frame interval;
receive, in accordance with the paging capability being associated with the first paging frame configuration, a second message indicating an authorization for the UE to receive one or more paging messages in accordance with the first paging frame configuration; and
receive, from the network node in accordance with receiving the second message, the one or more paging messages in accordance with the first paging frame configuration.

27. The UE of claim 26, wherein the second message is a radio resource control message, a non-access stratum message, or a user plane message.

28. The UE of claim 26, wherein:
the second message is a system information message; and
the authorization is associated with a UE class corresponding to the UE or a UE category corresponding to the UE.

29. The UE of claim 26, wherein execution of the processor-executable code further causes the UE to receive, from the network node, a system information message indicating whether the authorization applies to a current cell associated with the UE and/or whether the network node can selectively override the authorization.

30. The UE of claim 26, wherein execution of the processor-executable code further causes the UE to receive, from the network node, a system information message indicating the first paging frame configuration is enabled for all UEs within a cell having a respective paging capability associated with the first paging frame configuration or the first paging frame configuration is only enabled for one or more UEs within the cell authorized to use the first paging configuration.
